(19) United States
(12) Patent Application Publication
(10) Pub. No.: US 2007/0298656 A1
(43) Pub. Date: Dec. 27, 2007

(54) Switch apparatus for multiple high definition multimedia interface sources

(75) Inventor: Yen Tung He, Taichung City (TW)

Correspondence Address: CHARLES E. BAXLEY, ESQ., 90 JOHN STREET, THIRD FLOOR, NEW YORK, NY, 10038, US

(73) Assignee: Good Mind Industries Co., Ltd.

(21) Appl. No.: 11/472,860

(22) Filed: Jun. 22, 2006

(51) Int. Cl. H01R 13/648

(52) U.S. Cl. 439/607

(57) ABSTRACT

A switch apparatus for multiple High Definition Multimedia Interface (HDMI) sources comprises: at least two input units, each associated to an electronic product that provides HDMI signals; at least one output unit associated to a HDMI compatible audio-visual equipment; an automatic detecting/switching unit for automatically detecting an activated HDMI signal source and electrically connect the related input unit with said output unit to screen the audio/video thereof through the audio-visual equipment. By utilizing the switch apparatus to integrate multiple electronic products as HDMI signal sources with least one HDMI compatible audio-visual equipment accomplishes an integrated system of HDMI products that share single audio-visual equipment for presenting the contents played therethrough.

### BACKGROUND OF THE INVENTION

1. Field of the Invention

The present invention relates to switches and, more particularly, to a switch apparatus for integrating multiple electronic products that are High Definition Multimedia Interface (HDMI) sources.

2. Description of Related Art

The professed HDMI (High Definition Multimedia Interface) is the most advanced interface for audio and video transmission. HDMI provides a bandwidth of data transfer as wide as 5 Gbps for original sound signal and high definition video frequency without digital/analog converting beforehand, hence, it may obviate signal interference as well as attenuation and thereby ensure the intact audio and video presentation. The advantage of utilizing HDMI is that through merely single HDMI cable, synchronous audio and video transference can be possible therefore traditional signal sources such as S Terminal, Component Terminal and RGB Terminal can be completely superseded.

It is preferable to a consumer that HDMI presents high definition performance while facilitating simplifying home entertainment systems by integrating audio and video sources with only one HDMI cable. Therefore, multiple HDMI products, for instance, one or two HDMI DVD players, HDMI video game player and personal computer in a room can be integrated and share single HDMI compatible audio-visual equipment to demonstrate intact audio and video thereon.

### SUMMARY OF THE INVENTION

The primary technical concept of the present invention is to utilize one switch apparatus to assemble multiple electronic products which are HDMI signal sources with one or more HDMI compatible audio-visual equipments so that plural HDMI products may share minor audio-visual equipment(s) for presenting multiple audio-visual contents played therethrough.

The switch apparatus of the present invention comprises: at least two input units, each associated to an electronic product that provides HDMI signals such as a DVD player, a Set-Top Box, a game player, a video camera or the like; at least one output unit associated to an HDMI-compatible audio-visual equipment such as a plasma television, a liquid crystal display television and so forth; an automatic detecting/switching unit for automatically seeking the activated HDMI signal source and electrically connecting the input unit related to said signal source with said output unit for screening audio/video thereof on the audio-visual equipment; and a power supply unit for providing said input, output and detecting/switching units with electric power.

The objectives and advantages achieved by the present invention include the following.

The switch apparatus contributes to integrating multiple electronic products providing HDMI signals with minor HDMI-compatible display equipments and therefore simplifies the cabling system of the assembled HDMI audio-visual devices.

Moreover, the switch apparatus disclosed herein may automatically detect an activated HDMI source and accordingly screen the audio/video thereof through the assembled audio-visual display equipment. It would be preferably convenient to the users.

### BRIEF DESCRIPTION OF THE DRAWINGS

FIG. 1 is a block diagram illustrating the inner configuration of a switch apparatus in accordance with the present invention.

FIG. 2 is a schematic drawing showing the connection between the plural DVD players and the television through the switch apparatus.

FIG. 3 is a schematic drawing depicting the automatic detecting/switching unit of the invention dominating over the connections between each DVD player and the television under preset-sequence logic.

FIG. 4 is a schematic drawing depicting the automatic detecting/switching unit of the invention dominating over the connections between each DVD player and the television under time-sequence logic.

FIG. 5 is a schematic drawing showing the manual switching unit of the switch apparatus according to the present invention lying in between the DVD players and the television.

FIG. 6 is a block diagram illustrating the configuration of the switch apparatus according to the present invention getting equipped with the automatic detecting/switching unit and the manual switching unit simultaneously.

### DETAILED DESCRIPTION OF THE PREFERRED EMBODIMENT

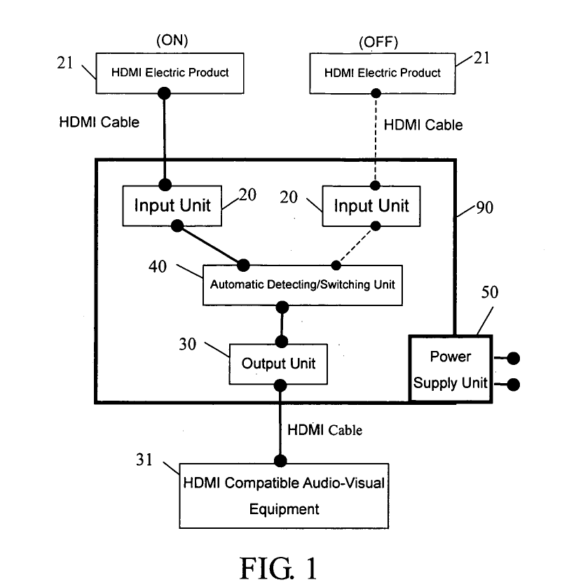

In FIG. 1, a switch apparatus 90 according to the present invention primarily comprises:

at least two input units 20, each associated to an electronic product 21 that provides HDMI signals such as a DVD player, a Set-Top Box, a game player, a video camera and the like;

at least one output unit 30 associated to an HDMI compatible audio-visual equipment 31 such as a plasma television, a liquid crystal display television and so forth;

an automatic detecting/switching unit 40 for automatically sensing an activated HDMI signal source and electrically connect the input unit 20 related to said activated source with said output unit 30 to screen the audio/video thereof through the assembled audio-visual equipment 31; and

a power supply unit 50 for providing said input, output and detecting/switching units with electric power.

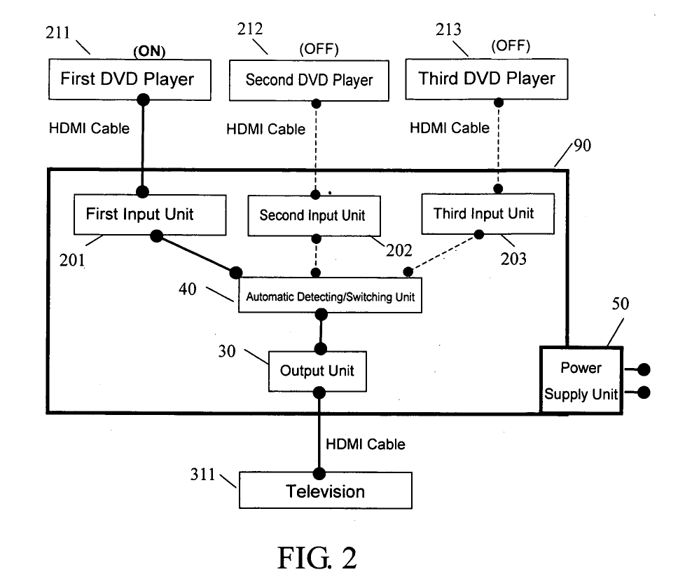

One embodiment is described herein for illustration. As shown in FIG. 2, said plural electronic products that provide HDMI signals are, for instance, DVD players 211, 212 and 213 which respectively named as the first player 211, second player 212 and third player 213 herein, and said HDMI compatible audio-visual equipment is, for instance, a television 311. The first player 211, second player 212 and third player 213 are respectively connected to the first, second and third input units 201, 202 and 203 of the switch apparatus 90 by means of HDMI cables. In addition, the television 311 is connected with the output unit 30 through a HDMI cable. For example, when the first DVD player 211 is turned on and the rest of the players 212, 213 are off, the automatic detecting/switching unit 40 seizes HDMI signals from the first input unit 201 and thus electrically connects the first input unit 201 with said output unit 30. Consequently, the television 311 displays the contents delivered by the first DVD player 211.

While the above described is understandable, what is the contents screened on the television subject to if more than one signal source is activated simultaneously? There are two approaches proposed by the present invention through the claimed switch apparatus.

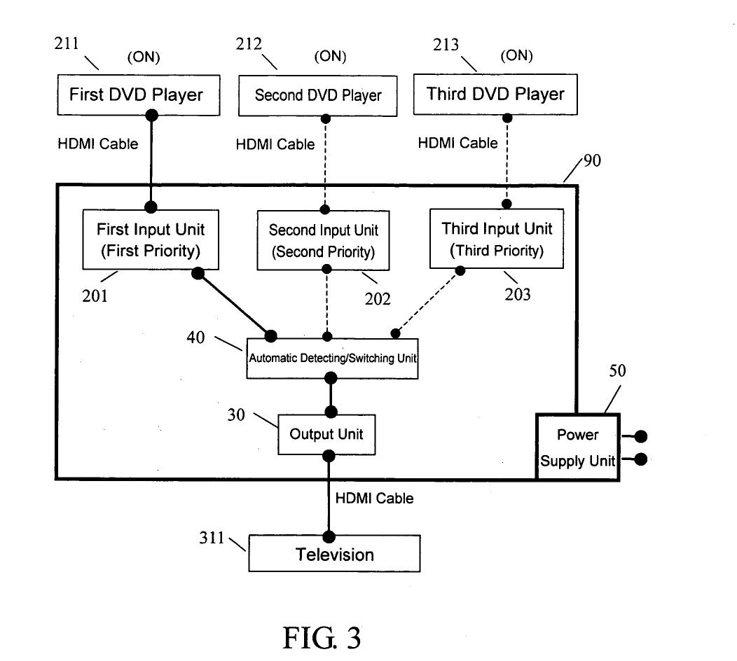

The first approach is accomplished by pre-programming the automatic detecting/switching unit 40 in preset-sequence logic. An order of priority of all the output units is preset, and therefore when signals come from plural input units simultaneously, the switch apparatus sifts the most-prior source and electrically connects it with the output unit. Referring to FIG. 3, according to the preset sequence, the input units 201, 202, 203 are respectively referred to the first priority, the second priority and the last priority. It's assumed that the first, second and third DVD players 211, 212, 213 are all on, then the automatic detecting/switching unit 40 which discovers the signals from all the three input units 201, 202, 203 only switches the most prior input unit, herein the first input unit 201, over the output unit 30 for electric connection. Thereupon, the television 311 screens the audio/video delivered from the first DVD player 211. If then the first DVD player 211 is turned off and the first input unit 201 therefore loses its signal source, the automatic detecting/switching unit 40 thus makes an eclectic connection between the output unit 30 and the most-prior input unit, presently the second input unit 202 to fill the television 311 with the audio/video played by the second DVD player 212 and the rest may be deduced by analogy.

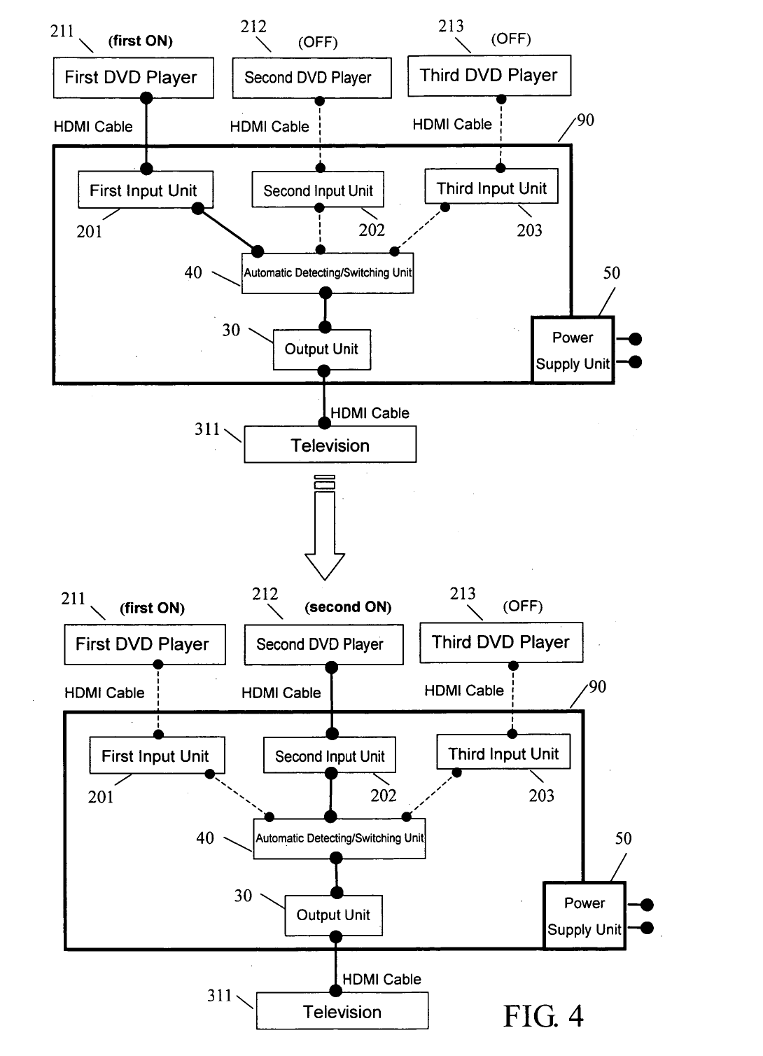

The alternative approach is to pre-program the automatic detecting/switching unit 40 in time-sequence logic. Such design is developed in view of normal user habits because when a user turns on plural DVD players successively, it is reasonable that he purposely intends to take the contents from the lately activated one. As shown in FIG. 4, if the first DVD player 211 remains on at the very beginning, the automatic detecting/switching unit 40 electrically connects the first input unit 201 to the output unit 30 and the television 311 therefore displays the audio/video related to the first DVD player 211. And later, when the second DVD player 212 is subsequently turned on, the time sequence logic of the automatic detecting/switching unit 40 leads the second input unit 202 which is related to the latest discovered signal source to take the place of the first input unit 201. Since the output unit 30 now is electrically connected with the second input unit 202, the television is switched to display the audio/video related to the second DVD player 212.

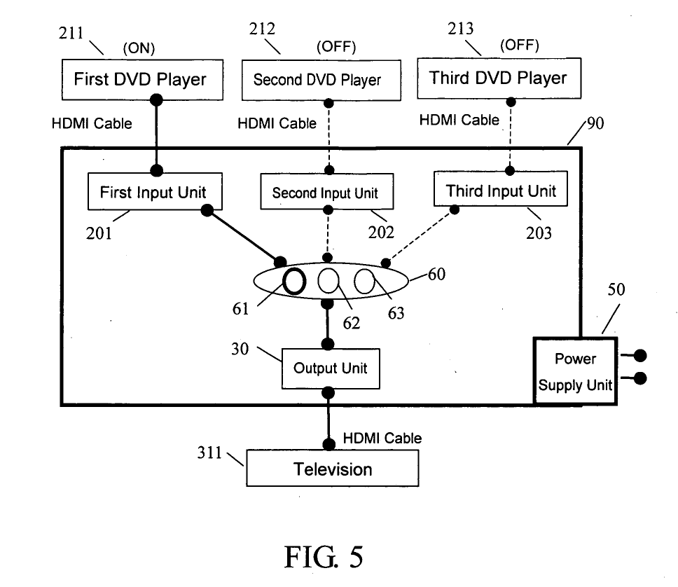

The switch apparatus of the disclosed subject matter may also contain a manual switching unit wherein several switches are each associated to each of the input units. When a user turns on one of the HDMI sources as well as the related switch, the related input unit is electrically connected with the output unit and consequently makes the signals derived from that HDMI source screened on the television 311. For example, in FIG. 5, the manual switching unit 60 includes a first switch 61, a second switch 62 and a third switch 63 which are respectively associated to the first, second and third DVD players 211, 212, 213. When a user turns on the first DVD players 211 and the first switch 61, the first input unit 201 is therefore electrically connected with the output unit 30 and the television 311 in turn screens the contents played by the first DVD player 211. Unless the first switch 61 is further shut off or the switch apparatus 90 may put no other input units 202, 203 through the output unit 30.

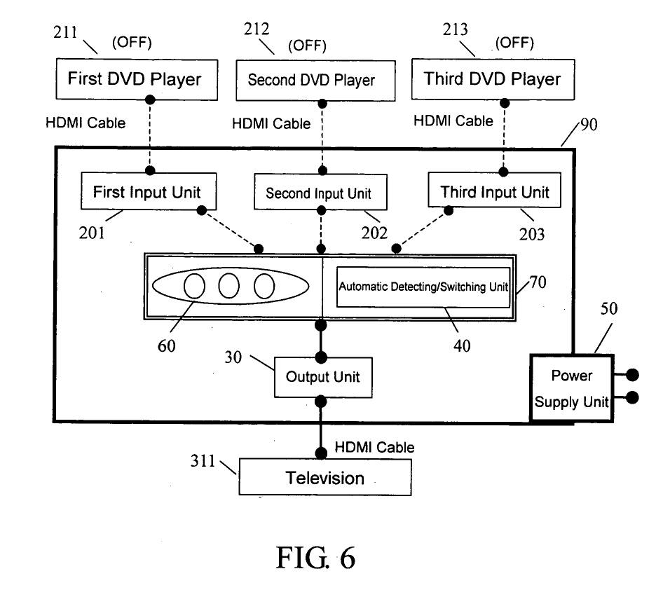

As shown in FIG. 6, when the manual switching unit 60 and the automatic detecting/switching unit 40 are equipped for an identical switch apparatus 90 simultaneously, a mode selector 70 may further be provided for exchanging the operating mode between the automatic mode and manual one.

The description of the present invention has been presented for purposes of illustration and description, and is not intended to be exhaustive or limited to the invention in the form disclosed. It will be understood by one of ordinary skill in the art that numerous variations will be possible to the disclosed embodiments without going outside the scope of the invention as disclosed in the claims.

What the invention claimed is:

1. A switch apparatus for multiple High Definition Multimedia Interface (HDMI) sources is characterized by:
at least two input units, each associated to an electric product that provides HDMI signals;
an output unit associated to an HDMI compatible audio-visual equipment;
an automatic detecting/switching unit for automatically detecting an active HDMI source and electrically connecting the input unit related to said active signal source with said output unit; and
a power supply unit for providing said input, output and detecting/switching units with electric power.

2. The switch apparatus for multiple High Definition Multimedia Interface (HDMI) sources as claimed in claim 1, wherein the automatic detecting/switching unit is pre-programmed with the priority list of the input units so that when plural HDMI sources are active, the input unit occupying the higher priority is electrically connected with the output unit precedentially.

3. The switch apparatus for multiple High Definition Multimedia Interface (HDMI) sources as claimed in claim 1, wherein the automatic detecting/switching unit automatically detects the time sequence of the sequentially activated HDMI sources and conducts the input unit related to the most lately activated HDMI source electrically connected with the output unit prior precedentially.

4. The switch apparatus for multiple High Definition Multimedia Interface (HDMI) sources as claimed in claim 1, wherein the switch apparatus further comprises a manual switching unit that includes switches each related to each input unit for controlling electric connections between the input units and the output unit.

5. The switch apparatus for multiple High Definition Multimedia Interface (HDMI) sources as claimed in claim 4, wherein the switch apparatus further comprises a mode selector for alternatively activating either the automatic detecting/switching unit or the manual switching unit.

6. A switch apparatus for multiple High Definition Multimedia Interface (HDMI) sources is characterized by:
at least two input units, each associated to an electric product that provides HDMI signals;
an output unit associated to a HDMI compatible audio-visual equipment;
a manual switching unit that includes switches related to each input unit for controlling electric connections between each input unit and the output unit; and
a power supply to provide said input, output, and manual switching units with electric power.
